(19) United States
(12) Patent Application Publication
(10) Pub. No.: US 2008/0024423 A1
(43) Pub. Date: Jan. 31, 2008

(54) METHOD AND DEVICE FOR DRIVING LIQUID CRYSTAL DISPLAY PANEL, AND LIQUID CRYSTAL DISPLAY DEVICE USING SAME

(75) Inventors: Tsuyoshi Ichiraku, Kanagawa (JP); Noriyuki Takagi, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: NEC LCD Technologies, Ltd., Kawasaki-shi (JP)

(21) Appl. No.: 11/782,257

(22) Filed: Jul. 24, 2007

(30) Foreign Application Priority Data
Jul. 31, 2006 (JP) 2006-208108

(51) Int. Cl. G09G 3/36

(52) U.S. Cl. 345/103

(57) ABSTRACT

A driving device for an LCD panel is provided which is capable of preventing the occurrence of light or dark shade among pixels during a non-writing period. All the pixels of the LCD panel are driven by each source driver to receive various signals from a control section and a reference voltage from a reference voltage generating section and each gate driver to receive a gate control signal from the control section using an AC voltage driving method. For a specified period of time after the ending of a writing period, a display data signal, an AC-DC voltage inverting control signal, a latch signal, and a reference voltage are fed to each source driver and an intermediate voltage of an AC driving voltage or a specified voltage is fed to data lines.

### INCORPORATION BY REFERENCE

This application is based upon and claims the benefit of priority from Japanese Patent Application No. 2006-208108, filed on Jul. 31, 2006, the disclosure of which is incorporated herein in its entirely by reference.

### BACKGROUND OF THE INVENTION

1. Field of the Invention

The present invention relates to a method and a device for driving a liquid crystal display (hereinafter, may be simply referred to as LCD) panel, and an LCD device using the same and more particularly to the method and the device for driving the LCD panel capable of reducing power consumption without impairing a quality of display, and the LCD device using the LCD panel.

2. Description of the Related Art

In recent years, in information terminal devices, a suppression of an increase in power consumption caused by enhanced functions is increasingly required. In portable phones being equipped with an LCD device or a like, a reduction of power consumption in the LCD device is progressed. Technology to reduce power consumption in the LCD device, that is, during a non-writing period in a frame period, to stop operations of a source driver IC (Integrated Circuit) and to control so that an output voltage is fixed or a high-impedance (Hi-Z) state is made to occur is known (Japanese Patent Application Laid-open No. 2003-233351). FIG. 6 is a timing chart explaining driving employed in the above disclosed technology. In the disclosed technology, during the non-writing period, continuous residing of DC (direct current) voltage components in data lines of an LCD panel is unavoidable. The non-writing period is a time period required for signal processing of a display data signal in a driving device.

Moreover, in an LCD device employing an AC (alternating current) voltage driving method such as a dot inversion driving method in which an AC voltage is applied in every other line or in every two or more lines, a writing voltage defined by an AC-DC voltage inverting condition and display data is applied in each pixel capacitor and the writing voltage is held in each pixel capacitor.

A means to reduce power consumption of a LCD panel is disclosed in Japanese Patent Application No. 2005-031595 in which an intermediate voltage between a high-level and low-level of a voltage to be applied to a facing electrode during a writing period is used as a voltage to be applied to the facing electrode during a non-writing period. Also, a means to solve a problem of an afterimage occurring when moving images are displayed in an LCD panel is disclosed in Japanese Patent Application No. 2006-011199 in which a voltage obtained by switching a gray level voltage and a fixed gray level voltage (intermediate voltage) to be applied to a pixel during a horizontal period for display moving pictures is applied to data lines.

In the LCD device employing the technology disclosed in the above Japanese Patent Application No. 2003-233351 and technology using the AC voltage driving method, a residual potential during the non-writing period is applied between a source and drain of each TFT formed in each pixel of the LCD panel, which causes leakage of a voltage depending on characteristics of the TFT and on the applied potential in some cases.

There is a big difference in potentials causing the leakage between each of pixel capacitors to which a positive voltage is applied and each of pixel capacitors to which a negative voltage is applied in the AC voltage driving method and, the larger an amount of the leakage during the non-writing period, though the amount varies depending on TFT characteristics or a lengthened period of the non-writing, the bigger the difference in potentials caused by charges residing in each pixel capacitor, which is perceived as a light or dark phenomenon and leads to a critical defect to cause degradation of the quality of display. Here, the degradation in the quality of display means that the light or dark phenomenon looks like a streak. However, if the voltage is changed to be an AC voltage even during the non-writing period (see FIG. 7), the amount of leakage from each pixel is averaged and, as a result, the light or dark phenomenon among pixels does not occur; however, there is a technological problem that an increase in power consumption is inevitable due to the inversion of the DC voltage to the AC voltage in the conventional technology.

Moreover, in the technology disclosed in the above Japanese Patent Application Laid-open No. 2005-031595, the voltage to be applied to the facing electrode during a displaying period (equivalent to writing period) is switched and used as a voltage to be applied during a non-displaying period (equivalent to non-writing period); however, in this case also, the reduction in power consumption is still insufficient. In the technology disclosed in the Japanese Patent Application Laid-open No. 2006-011199, a voltage obtained by switching between a gray level voltage and fixed gray level voltage (intermediate voltage) to be applied to each pixel during a horizontal period in displaying of moving pictures is applied to data lines; however, this technology does not solve the above problems occurring during the above non-writing period.

### SUMMARY OF THE INVENTION

In view of the above, it is an object of the present invention to provide a method and a device for driving an LCD panel capable of reducing power consumption without impairing the quality of display, and an LCD device using the LCD panel.

According to a first aspect of the present invention, there is provided a driving method of an LCD panel including a plurality of signal electrodes arranged in parallel to one another along a first direction, a plurality of scanning electrodes arranged in parallel to one another along a second direction orthogonal to the first direction and a plurality of pixel regions arranged in a manner to correspond, in a one-to-one relationship, to an intersection of each of the signal electrodes and each of the scanning electrodes, the driving method including:

applying a driving voltage determined by an image signal to each of corresponding signal electrodes and a scanning voltage to each of corresponding the scanning electrodes in every frame writing period for writing the image signal by using an AC voltage driving method;

applying an equalizing voltage to uniform a quantity of electricity leaking from each of pixel capacitors in each of the pixel regions to each of the signal electrodes for a partial period of a non-writing period being interposed between one frame writing period and its succeeding frame writing period and then, after stopping the application of the equalizing voltage, exerting high-impedance control for a remaining period of the non-writing period.

In the foregoing, a preferable mode is one wherein a time required to apply the driving voltage to each of the signal electrodes using the AC voltage driving method is equal to a time required to apply the scanning voltage to the scanning electrodes.

Also, a preferable mode is one wherein a time required to apply the driving voltage to each of the signal electrodes by using the AC voltage driving method is shorter than a time required to apply the scanning voltage to the scanning electrodes.

Also, a preferable mode is one wherein the equalizing voltage is an intermediate voltage of an AC driving voltage or a specified voltage.

Also, a preferable mode is one wherein the equalizing voltage is applied simultaneously or at a different time to each of the signal electrodes.

According to a second aspect of the present invention, there is provided a driving device for driving an LCD panel including a plurality of signal electrodes arranged in parallel to one another along a first direction, a plurality of scanning electrodes arranged in parallel to one another along a second direction orthogonal to the first direction and a plurality of pixel regions arranged in a manner to correspond, in a one-to-one relationship, to an intersection of each of the signal electrodes and each of the scanning electrodes, the driving device including:

a first applying unit to apply a driving voltage determined based on an image signal to corresponding the signal electrode in every frame writing period for writing the image signal on the LCD panel by using an AC voltage driving method;

a second applying unit to apply a scanning voltage to the scanning electrodes in every the frame writing period by using the AC voltage driving method;

a third applying unit to apply an equalizing voltage to uniform a quantity of electricity leaking from each of pixel capacitors in each of the pixel regions. The equalizing voltage is applied to each of the signal electrodes for a partial period of a non-writing period being interposed between one frame writing period and its succeeding frame writing period. Then, after stopping the application of the equalizing voltage. High-impedance control is exerted for a remaining period of the non-writing period.

In the foregoing, a preferable mode is one wherein a time required to apply the driving voltage to each of the signal electrodes using the AC voltage driving method is equal to a time required to apply the scanning voltage to the scanning electrodes.

Also, a preferable mode is one wherein a time required to apply the driving voltage to each of the signal electrodes by using the AC voltage driving method is shorter than a time required to apply the scanning voltage to the scanning electrodes.

Also, a preferable mode is one wherein the equalizing voltage is an intermediate voltage of an AC driving voltage or a specified voltage. The specified voltage described above denotes a voltage having been confirmed as not impairing the display quality.

Also, a preferable mode is one wherein the equalizing voltage is applied simultaneously or at a different time to each of the signal electrodes.

Also, a preferable mode is one wherein the third applying unit includes:

a reference voltage generating section to output a reference voltage;

a control section to generate a display data signal, an AC-DC voltage inverting control signal, and a latch signal during the non-writing period; and

a driver connected to the reference voltage generating section and the control section to apply the intermediate voltage or the specified voltage simultaneously or at a different time to each of the signal electrodes based on the reference voltage, the display data signal, the AC-DC voltage inverting control signal, and the latch signal.

Also, a preferable mode is one wherein the third applying unit includes:

a reference voltage generating section to output a reference voltage;

a control section to generate an output switching control signal during the non-writing period;

a driver connected to the reference voltage generating section and the control section to apply the intermediate voltage or the specified voltage simultaneously or at a different time to each of the signal electrodes based on the reference voltage and the output switching control signal.

Also, a preferable mode is one wherein the control section of the third applying unit outputs a high-impedance control signal during a time period from termination of the application of the equalizing voltage in the non-writing period to the start of a succeeding frame writing period and wherein an output from the driver gets into a high-impedance state in response to the high-impedance control signal.

Furthermore, a preferable mode is one wherein the control section of the third applying unit makes the latch signal to be applied to the driver be at a high level for outputting during a time period from termination of the application of the equalizing voltage in the non-writing period to the start of a succeeding frame writing period.

According to a third aspect of the present invention, there is provided an LCD device, a driving device connected to the LCD panel wherein the driving device includes the driving device for the LCD panel described above.

With the above configurations, for a specified period of the non-writing period after having driven all the pixel regions each being formed in every intersection of the plurality of signal electrodes and the plurality of scanning electrodes formed so as to be orthogonal to the plurality of signal electrodes in a specified order within a frame writing period, an equalizing voltage to reduce variations in an leaked voltages among pixel capacitors in the above pixel regions is applied to each of the data lines and, therefore, the amount of leaked voltage accumulated in each of the pixel capacitors during the non-writing period is uniformed among pixel capacitors in the pixel regions. This enables prevention of an occurrence of light or dark phenomenon caused by variations (differences) in the leaked voltage among pixel regions and of degradation of display quality. Moreover, a stop of driving operations during the non-writing period and the setting of an output of the source drivers to be in a high-impedance state serve to reduce power consumption.

### BRIEF DESCRIPTION OF THE DRAWINGS

The above and other objects, advantages, and features of the present invention will be more apparent from the following description taken in conjunction with the accompanying drawings in which:

FIG. 1 is a diagram showing electrical configurations of a driving device for an LCD panel according to a first embodiment of the present invention;

FIG. 2 is a diagram showing configurations of a pixel of the LCD panel according to the first embodiment of the present invention;

FIG. 3 is a driving timing chart of a driving device for the LCD panel according to the first embodiment of the present invention;

FIG. 4 is a diagram showing electrical configurations of a driving device for an LCD panel according to a second embodiment of the present invention;

FIG. 5 is a driving timing chart of a driving device for the LCD panel according to the second embodiment of the present invention;

FIG. 6 is a driving timing chart showing a first driving timing in a conventional LCD device; and

FIG. 7 is a driving timing chart showing a second driving timing in the conventional LCD device.

### DETAILED DESCRIPTION OF THE PREFERRED EMBODIMENTS

Best modes of carrying out the present invention will be described in further detail using various embodiments with reference to the accompanying drawings. The method of driving an LCD device of the present invention includes a step of applying an equalizing voltage to reduce variations in the leaked voltages among pixel capacitors in pixel regions is applied to each data line for a specified period of a non-writing period after having driven all pixel regions within a frame writing period.

### First Embodiment

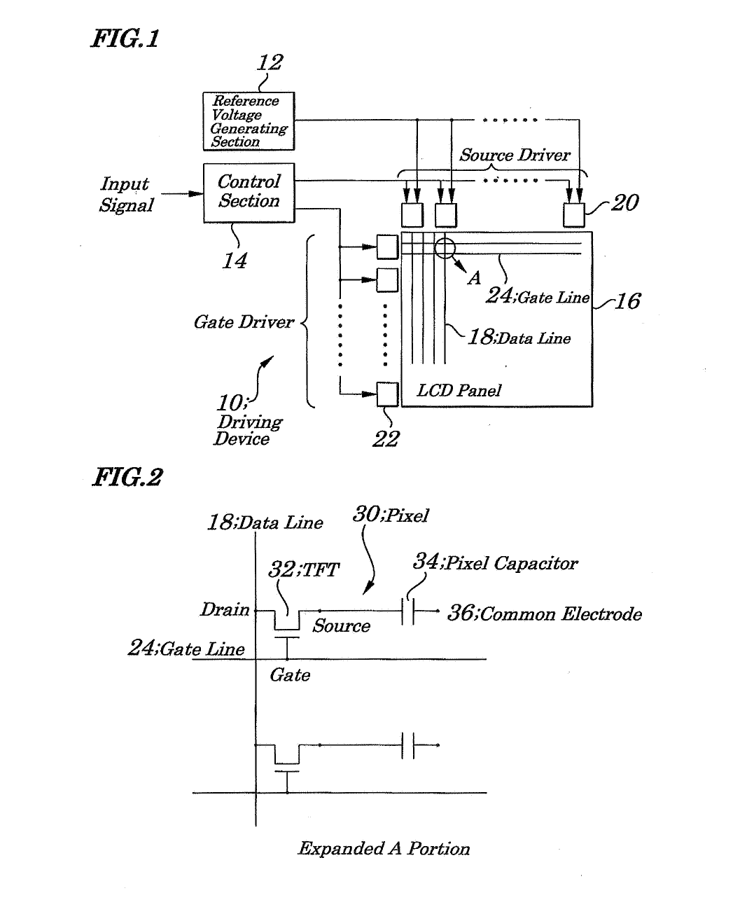

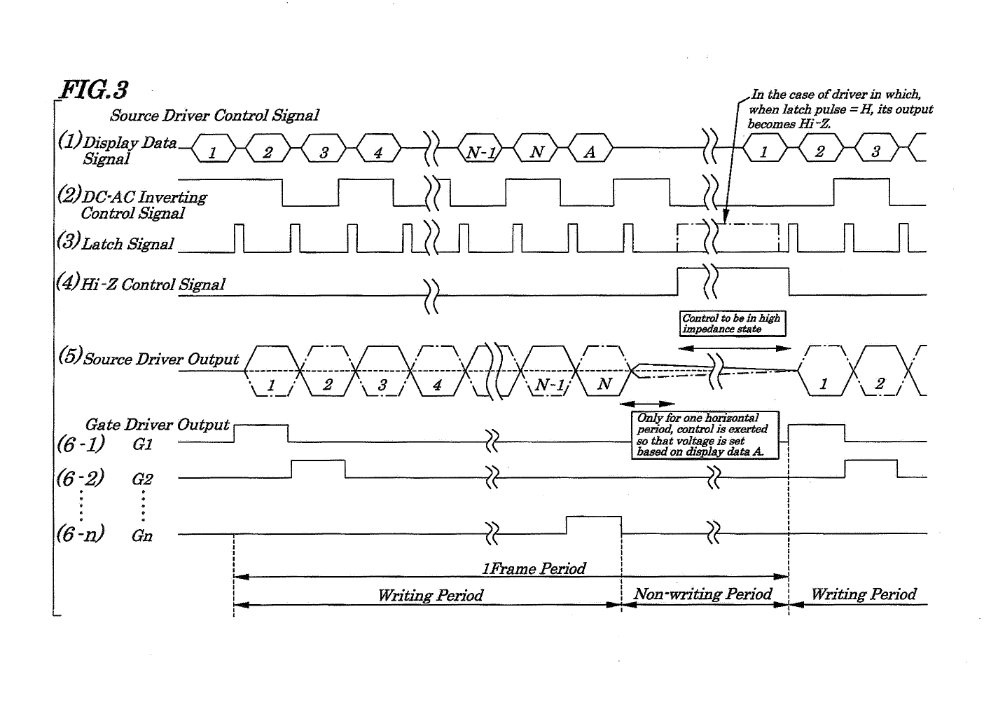

FIG. 1 is a diagram showing electrical configurations of a driving device for an LCD panel according to a first embodiment of the present invention. FIG. 2 is a diagram showing configurations of a pixel of the LCD panel according to the first embodiment. FIG. 3 is a driving timing chart explaining a driving device for the LCD panel according to the first embodiment. In the driving device 10 for the LCD panel according to the first embodiment, when each pixel of the LCD panel is driven line-sequentially, a voltage is output, which acts to reduce variations in an amount of electrical leakage (leaking amount of electricity, for example, current, voltage or amount of charges) among pixels, to corresponding data lines from each source driver. The LCD device, as shown in FIG. 1, chiefly includes a reference voltage generating section 12, a control section to send out a control signal, in response to an input signal, to source drivers 20 and gate drivers 22, the source drivers 20 connected to each data line 18 of the LCD panel 16, and gate drivers 22 connected to each gate line 24 of the LCD panel 16.

The reference voltage generating section 12 is a voltage outputting section to output a plurality of positive and negative reference voltages required to generate a writing voltage corresponding to a gray level to be employed in the AC voltage driving method to the source driver 20. Moreover, the writing voltage may include an intermediate voltage of the AC voltage or a specified voltage. The reference voltage generating section 12 is made up of a resistance type potential divider or a like. The control section 14 is a signal outputting section to sequentially outputs a display data signal, a DC-AC voltage inverting control signal, a latch signal, and a Hi-Z control signal to the source driver 20 and send out a gate driver control signal to each of the gate driver. The display data signal, DC-AC voltage inverting control signal, latch signal, gate driver control signal are sequentially output in every horizontal period of the writing period. The writing period is a time required to write one frame of each display data signal corresponding to a pixel into each pixel (pixel region) of the LCD panel 16.

The display data signal is a signal used to transfer pixel gray level data produced based on a white data signal, black data signal, or input signal (image signal) for each line during a writing period (a frame writing period) in frames making up an image and the display data ([A] in FIG. 3) used to apply an intermediate voltage of an alternating voltage driving voltage or a specified voltage (S-voltage) to a data line, for example, for one horizontal period from a start time of a non-writing period. The non-writing period is time required for signal processing of the display data signal in the driving device 10. The specified voltage described above denotes the designed voltage having been confirmed as not impairing the display quality. The DC-AC voltage inverting-control signal is a control signal to invert a writing voltage for each pixel in every frame. The latch signal is a control signal to capture a writing signal corresponding to a display data signal at its leading edge and to output the writing voltage from the source driver 20 to the data line 18 at its trailing edge.

The Hi-Z control signal goes high for a specified period of time following a start point of time of the non-writing period, for example, from a terminating point of time of one horizontal period to a terminating point of time of a non-writing period and is used to set an output from the source driver 20 to be in a high-impedance state. Alternatively, instead of the use of the Hi-Z control signal, for the period during which the Hi-Z control signal goes high, a signal level of the latch signal is made to go high to set an output from the source driver 20 to be in a high-impedance state.

The source driver 20 is a voltage applying section to apply a positive or negative writing voltage corresponding to contents of display data signal to data lines (signal electrodes) under control of the display data signal (pixel data signal), DC-AC voltage inverting control signal and latch signal to be fed from the control section 14. The gate driver 22 is a voltage applying section to apply a gate signal to corresponding gate lines (scanning electrodes) 24 in every horizontal period of writing periods of images to be line-sequentially displayed on the LCD panel 16.

FIG. 2 is a diagram showing the portion indicated by a reference letter “A” in FIG. 1, that is, a pixel (pixel region). The pixel 30 is made up of a TFT 32 whose gate is connected to the gate line 24 and whose drain is connected to the data line 18 and of a pixel capacitor 34 whose one electrode is connected to a source of the TFT 32 and whose another electrode is connected to the common electrode 36.

Operations of the driving device of the LCD device of the embodiment are described by referring to FIGS. 1, 2, and 3, Each pixel is driven during a writing period for each frame of the LCD panel 16 of the embodiment by the AC voltage driving method as in the conventional cases. The operations are shown in (1), (2), . . . , (6-1), (6-2), . . . , (6-2) in FIG. 3. That is, when a signal (display data) is input to the control section 14, a display data signal, DC-AC inverting control signal, and latch signal output from the control section 14 in response to the input signal are applied to each of the source drivers 20. The source drivers 20 simultaneously and sequentially apply, based on a reference voltage corresponding to a display data signal out of reference voltages output from the reference voltage generating section 12 and in the order determined by the DC-AC voltage control signal and latch signal fed from the control section 14, a driving voltage (writing voltage) to each of the data lines 18, while each of the gate drivers 22 sequentially applies a gate signal for a horizontal period to the gate lines 24 that operate line-sequentially. Thus, display corresponding to the display data signal described above occurs on each pixel of the LCD panel 16 and an image corresponding to input signal appears on the screen of the LCD panel.

When a non-writing period starts after the ending of the writing period for one frame in image displaying, that is, after the ending of driving of a final line (during the final horizontal period), each of the source drivers 20 simultaneously applies a writing voltage to be employed for the non-writing period which is generated based on an intermediate voltage of the AC voltage driving voltage or a specified voltage to be fed from the reference voltage generating section or a required reference voltage also fed from the reference voltage generating section 12 to all corresponding data lines 18 in response to a display data signal, DC-AC voltage inverting control signal, and latch signal fed from the control section 14 during one horizontal period from the start point of time of the non-writing period. The intermediate voltage of the AC voltage is not necessarily the same as the writing voltage to be employed for the non-writing period.

By applying the writing voltage to be employed for the non-writing period to the data lines 18 for one horizontal period following the start time of the non-writing period after the ending of the above writing period, following effects can be obtained. The writing voltage to be written into each pixel capacitor according to the AC voltage driving method varies depending on the display data signal and DC-AC voltage inverting conditions and is held until a succeeding frame starts, while DC voltage components reside in the data lines used to write the writing voltage into each pixel capacitor. Both the writing voltage and the DC voltage components gradually decay with a time constant of discharges and are leaked for a period of time before a succeeding frame.

Therefore, a potential applied between the source and the drain of the TFT of each pixel during the non-writing period in each frame period varies greatly between pixels in an odd-numbered line (to which a positive writing voltage is applied) and pixels in an even-numbered line (to which a negative writing voltage is applied). This causes variations in the amount of leaked currents among pixel capacitors.

However, according to the first embodiment, for one horizontal period following the start time of the non-writing period, the writing voltage (S-voltage) for the non-writing period is applied to each of the data lines 18 and, therefore, a difference in potential between the source and drain of the TFT of each pixel is made equal, which causes small variations in leaked currents occurring at a time of an OFF period of the TFT among pixels, regardless of whether pixels each on an odd-numbered line or on an even-numbered lines. That is, the amount of leakage of the voltage accumulated in the pixel capacitor during the non-writing period is made equal among pixels and, as a result, the occurrence of light or dark shade caused by variations in the amount of leakage among pixels can be avoided, thus enabling the prevention of degradation in display quality.

Then, after the application of the writing voltage (S-voltage) for the non-writing period to the data lines 18, not only the AC-DC voltage inverting control signal, but also the control signal itself to be output is stopped ([2] in FIG. 3). This results to reduce power consumption. Moreover, at a time of the completion of application of the writing voltage to be employed for the non-writing period to the data lines 18, a high-impedance (Hi-Z) control signal is supplied from the control section 14 to the source driver 20 (see [4] in FIG. 3). This sets an output from the source driver 20 to be in a high-impedance state and, therefore, power consumption is further reduced.

Thus, according to the first embodiment, the writing voltage for the non-writing period is applied to each of the data lines for one horizontal period following the start time of the non-writing period in a frame period and, therefore, differences in voltage between the source and drain of the TFT of each pixel are uniformed, as a result, the leaked voltages accumulated in each pixel capacitor during the non-writing period becomes equal, thus enabling prevention of the occurrence of light or dark caused by the variations in the amount of leaked voltages in each pixel and prevention of degradation of display quality. In addition, the stop of driving operations or setting of an output from the source driver enables further reduction of power consumption.

### Second Embodiment

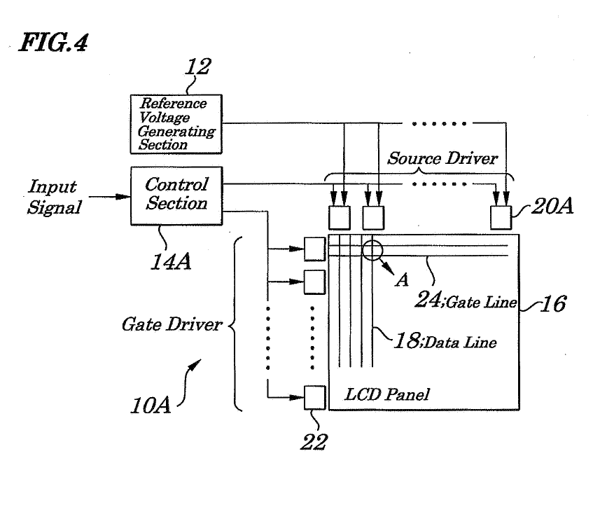

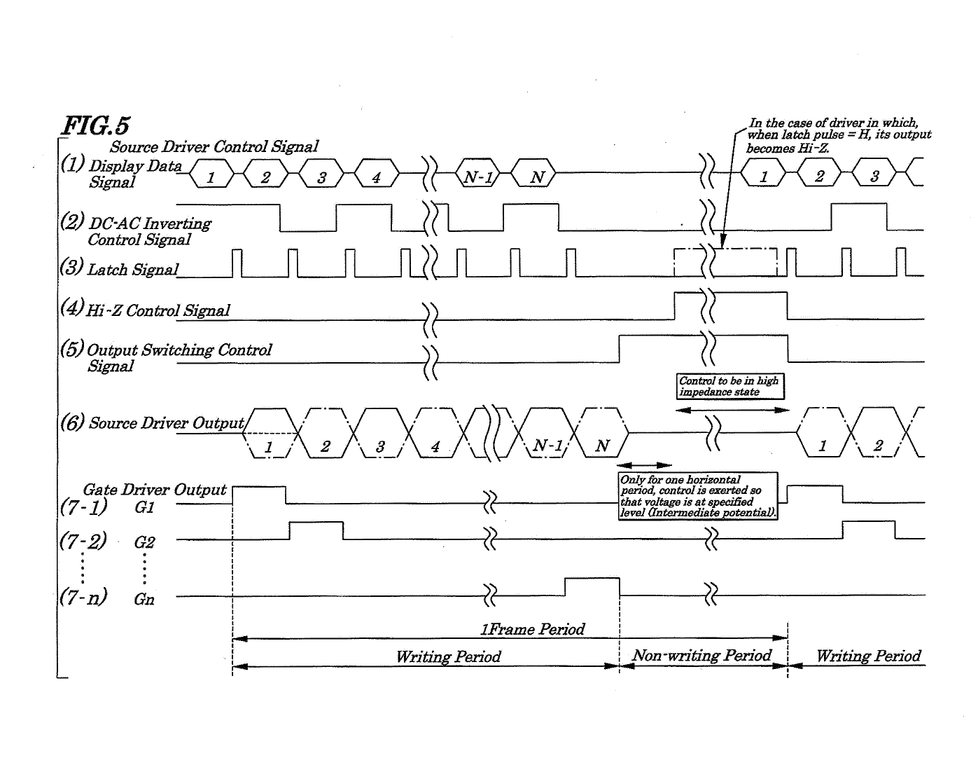

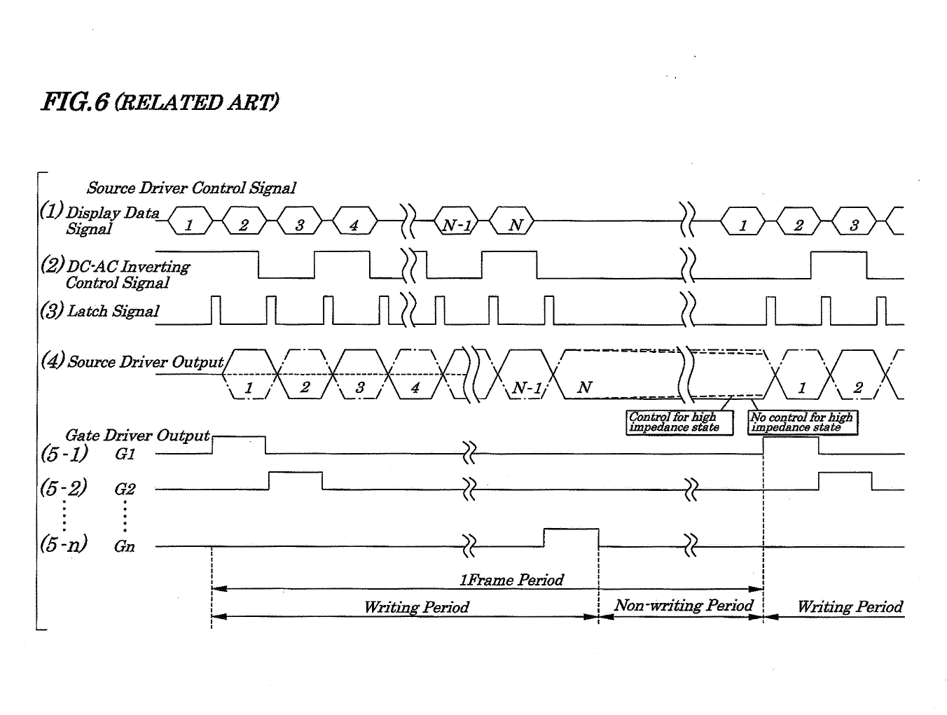

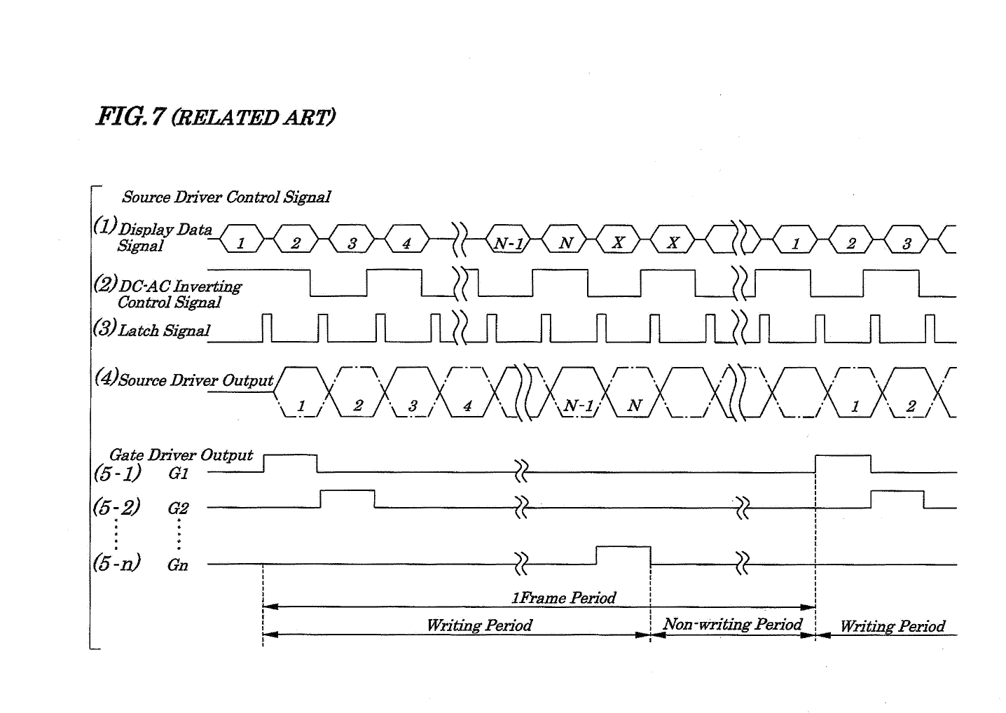

FIG. 4 is a diagram showing electrical configurations of a driving device for an LCD panel according to a second embodiment of the present invention. FIG. 5 is a timing chart explaining driving of the driving device for the LCD panel according to the second embodiment. The LCD panel of the second embodiment differs greatly from that of the first embodiment in that an application of a writing voltage for a non-writing period to each line data is performed not under a control of a DC-AC voltage control signal but under a control of an output switching control-signal.

A characterizing portion of the driving device of the LCD panel of the second embodiment in FIGS. 4 and 5 is that a control section 14A and source drivers 20A are configured as follows. The control section is configured so as to output, in addition to a display data signal ([1] in FIG. 5), a DC-AC voltage inverting control signal ([2] in FIG. 5), a latch signal ([3] in FIG. 5), and a Hi-Z control signal ([4] in FIG. 5) outputted during a writing period as is the case of the first embodiment, a high-level output switching control signal ([5] in FIG. 5) during a non-writing period. Also, the control section 14A, though not shown in FIG. 5, sequentially outputs a gate driver control signal to a gate driver 22 during a horizontal period in every horizontal period of the writing period.

Moreover, each of the source drivers 20A sequentially outputs, in response to the display data signal, DC-AC voltage inverting control signal, and latch signal, writing voltage with a gray level corresponding to the display data signal to corresponding data lines 18 during the horizontal period of the writing period. The Hi-Z control signal lets an output from each of the source drivers 20A get into a high-impedance state ([4] in FIG. 5) and, instead of the Hi-Z control signal, a latch signal can be used to let the output from each of the source drivers get into the high-impedance state ([3] in FIG. 5) by the same ways employed in the first embodiment. Each of the source drivers 20A outputs, in response to a high-level output switching control signal fed from the control section 14A during the non-writing period in every frame period, a specified voltage (intermediate voltage of AC driving voltage or specified voltage) for a specified period of time during the non-writing period directly following the writing period from the ending time of the previous writing period in every frame period, for example, during one horizontal period. Configurations of the second embodiment other than above are the same as those in the first embodiment and, therefore, same reference numbers are assigned to components having the same functions as the first embodiment and their descriptions are omitted accordingly.

Next, operations of the second embodiment are described by referring to FIGS. 4 and 5. Writing operations on the LCD device according to the second embodiment during the writing period are the same as in the first embodiment. When a non-writing period starts after the ending of a writing period for one frame in image displaying, that is, after the termination of writing in a final line (final horizontal period), each of the source drivers 20A, in response to the output switching control signal fed from the control section 14A during the non-writing period, simultaneously outputs a specified voltage, for example, a writing voltage for the non-writing period which is generated based on a specified voltage or a reference voltage fed from a reference voltage generating section 12, to all the data lines 18 for a specified period from the start time of the non-writing period, for example, during one horizontal period.

Following effects can be obtained by applying a writing voltage for the non-writing period to the data lines 18 for a specified period of time from the start time of the non-writing period. A writing voltage to be written into each pixel capacitor according to the AC driving method is a value obtained in a manner to correspond to a display data signal and DC-AC voltage inverting control signal and is held until a succeeding frame, while DC voltage components reside in data lines used to write the writing voltage into each of the pixel capacitors. Both the writing voltage and DC voltage components gradually decay with a time constant of discharges and are leaked for a period of time before a succeeding frame.

Therefore, a potential applied between a source and a drain of a TFT of each pixel during the non-writing period in each frame period varies greatly between pixels in an odd-numbered line (to which a positive writing voltage is applied) and pixels in a even-numbered line (to which a negative writing voltage is applied). This causes variations in the amount of leaked currents among pixel capacitors.

However, according to the second embodiment, for one horizontal period following the start time of the non-writing period, the writing voltage (S-voltage) for the non-writing period is applied to each of the data lines 18 and, therefore, variations in potential between the source and the drain of the TFT of each pixel is made uniform, which causes reduced variations in leaked currents occurring at a time of an OFF period of the TFT between the odd-numbered pixel and even-numbered pixels. That is, the amount of the leaked voltage accumulated in the pixel capacitor during the non-writing period is made uniform in each pixel and, as a result, occurrence of light or dark shade caused by variations in an amount of leakage among pixels can be avoided, thus enabling a prevention of degradation in display quality.

Then, after receiving the display data signal during the writing period described above, supply of the DC-AC inverting control signal is stopped, which, as a result, reduces power consumption. Moreover, at a time of the termination of application of the writing voltage (S-voltage) for the non-writing period to the data lines 18, a high-impedance (Hi-Z) control signal is applied from the control section 14A to the source driver 20A ([4] in FIG. 5). Or, the latch signal is made to go high. This sets an output from the source driver to be in a high-impedance state, which leads to further reduction of power consumption.

Thus, according to the second embodiment, for one horizontal period following the start time of the non-writing period, the writing voltage to be employed for the non-writing period is applied to each of the data lines 18. Therefore, variations in potential between the source and drain of the TFT of each pixel are uniformed and the amount of the leaked voltage accumulated in the pixel capacitor during the non-writing period is made equal in each pixel and, as a result, the occurrence of light or dark shade caused by the variations in the amount of leakage among pixels can be avoided, thus enabling the prevention of degradation in display quality. In addition, the stop of driving during the non-writing period or the setting of an output from the source drivers to be in a high-impedance state enables reduction of power consumption.

It is apparent that the present invention is not limited to the above embodiments but may be changed and modified without departing from the scope and object of the invention. For example, in the above embodiments, in the driving operations of the LCD device, an intermediate voltage of the AC voltage driving voltage or a specified voltage is applied during a specified period of the non-writing period; alternatively, a voltage that can reduce the variations in the amount of leakage among pixels may be applied. Moreover, it is not necessary that the specified periods for applying the above voltage to the data lines are successive The present invention can be realized even if the AC voltage driving method to be performed, as a line-sequential driving, not only in every one line but also in every two lines.

In addition, the driving method of the LCD panel and its driving device of the present invention can be used as various display devices, for example, information processing devices, portable terminal devices, display device for video cameras, television sets, or a like.

What is claimed is:

1. A driving method of a liquid crystal display panel comprising a plurality of signal electrodes arranged in parallel to one another along a first direction, a plurality of scanning electrodes arranged in parallel to one another along a second direction orthogonal to said first direction and a plurality of pixel regions arranged in a manner to correspond, in a one-to-one relationship, to an intersection of each of said signal electrodes and each of said scanning electrodes, said driving method comprising:
applying a driving voltage determined by an image signal to each of corresponding said signal electrodes and a scanning voltage to each of corresponding said scanning electrodes in every frame writing period for writing said image signal by using an alternating current voltage driving method;
applying an equalizing voltage to uniform a quantity of electricity leaking from each of pixel capacitors in each of said pixel regions to each of said signal electrodes, for a partial period of a non-writing period, being interposed between one frame writing period and its succeeding frame writing period and then, after stopping the application of said equalizing voltage, exerting high-impedance control for a remaining period of said non-writing period.

2. The driving method of the liquid crystal display panel according to claim 1, wherein a time required to apply said driving voltage to each of said signal electrodes using said alternating current voltage driving method is equal to a time required to apply said scanning voltage to said scanning electrodes.

3. The driving method of the liquid crystal display panel according to claim 1, wherein a time required to apply said driving voltage to each of said signal electrodes by using said alternating current voltage driving method is shorter than a time required to apply said scanning voltage to said scanning electrodes.

4. The driving method of the liquid crystal display panel according to claim 1, wherein said equalizing voltage is an intermediate voltage of an alternating current driving voltage or a specified voltage.

5. A driving device for driving a liquid crystal display panel comprising a plurality of signal electrodes arranged in parallel to one another along a first direction, a plurality of scanning electrodes arranged in parallel to one another along a second direction orthogonal to said first direction and a plurality of pixel regions arranged in a manner to correspond, in a one-to-one relationship, to an intersection of each of said signal electrodes and each of said scanning electrodes, said driving device comprising:
a first applying unit to apply a driving voltage determined based on an image signal to corresponding the signal electrode in every frame writing period for writing said image signal on said liquid crystal display panel by using an alternating current voltage driving method;
a second applying unit to apply a scanning voltage to said scanning electrodes in every the frame writing period by using the alternating current voltage driving method;
a third applying unit to apply an equalizing voltage to uniform a quantity of electricity leaking from each of pixel capacitors in each of said pixel regions to each of said signal electrodes for a partial period of a non-writing period being interposed between one frame writing period and its succeeding frame writing period and then, after stopping the application of said equalizing voltage, exerting high-impedance control for a remaining period of said non-writing period.

6. The driving device for driving the liquid crystal display panel according to claim 5, wherein a time required to apply said driving voltage to each of said signal electrodes using said alternating current voltage driving method is equal to a time required to apply said scanning voltage to said scanning electrodes.

7. The driving device for driving the liquid crystal display panel according to claim 5, wherein a time required to apply said driving voltage to each of said signal electrodes by using said alternating current voltage driving method is shorter than a time required to apply said scanning voltage to said scanning electrodes.

8. The driving device for driving the liquid crystal display panel according to claim 5, wherein said equalizing voltage is an intermediate voltage of an alternating current driving voltage or a specified voltage.

9. The driving device for driving the liquid crystal display panel according to claim 5, wherein said third applying unit comprises:
a reference voltage generating section to output a reference voltage;
a control section to generate a display data signal, an AC-DC (alternating current-direct current) voltage inverting control signal, and a latch signal during said non-writing period; and
a driver connected to said reference voltage generating section and said control section to apply said intermediate voltage or said specified voltage, simultaneously or at a different time, to each of said signal electrodes based on said reference voltage, said display data signal, said AC-DC voltage inverting control signal, and said latch signal.

10. The driving device for driving the liquid crystal display panel according to claim 9, wherein said control section of said third applying unit outputs a high-impedance control signal during a time period from termination of the application of said equalizing voltage in said non-writing period to the start of a succeeding frame writing period and wherein an output from said driver gets into a high-impedance state in response to said high-impedance control signal.

11. The driving device for driving the liquid crystal display panel according to claim 9, wherein said control section of said third applying unit makes said latch signal to be applied to said driver be at a high level for outputting during a time period from termination of the application of said equalizing voltage in said non-writing period to the start of a succeeding frame writing period.

12. The driving device for driving the liquid crystal display panel according to claim 5, wherein said third applying unit comprises:
a reference voltage generating section to output a reference voltage;
a control section to generate an output switching control signal during said non-writing period;
a driver connected to said reference voltage generating section and said control section to apply said intermediate voltage or said specified voltage simultaneously or at a different time to each of said signal electrodes based on said reference voltage and said output switching control signal.

13. The driving device for driving the liquid crystal display panel according to claim 12, wherein said control section of said third applying unit outputs a high-impedance control signal during a time period from termination of the application of said equalizing voltage in said non-writing period to the start of a succeeding frame writing period and wherein an output from said driver gets into a high-impedance state in response to said high-impedance control signal.

14. The driving device for driving the liquid crystal display panel according to claim 12, wherein said control section of said third applying unit makes said latch signal to be applied to said driver be at a high level for outputting during a time period from termination of the application of said equalizing voltage in said non-writing period to the start of a succeeding frame writing period.

15. A liquid crystal display device comprising a liquid crystal display panel, a driving device connected to said liquid crystal display panel wherein said driving device comprises the driving device for the liquid crystal display panel as defined in claim 5.
